(19) United States
(12) Patent Application Publication
(10) Pub. No.: US 2012/0188120 A1
(43) Pub. Date: Jul. 26, 2012

(54) METHOD AND APPARATUS FOR POSITIONING

(75) Inventors: Shuan-Chi Tsai, Tainan City (TW); Jean-Fu Kiang, Taipei City (TW)

(73) Assignee: INDUSTRIAL TECHNOLOGY RESEARCH INSTITUTE, Hsinchu (TW)

(21) Appl. No.: 13/082,424

(22) Filed: Apr. 8, 2011

(30) Foreign Application Priority Data
Jan. 26, 2011 (TW) 100102943

(51) Int. Cl. G01S 19/41

(52) U.S. Cl. 342/357.24

(57) ABSTRACT

A positioning method and a positioning apparatus are provided. In this positioning method, a differential global positioning system is used to calculate a double difference of satellite distance in connection with a reference station and a receiver station. A baseline vector pointing from the reference station to the receiver station is calculated according to the double difference of satellite distance and the cosine law. The baseline vector and the position of the reference station are used to calculate the position of the receiver station. Correction coefficients are obtained according to the position of the reference station, the position of the receiver station, and the current time. The position of the receiver station is corrected according to the correction coefficients and the length of the baseline vector.

### CROSS-REFERENCE TO RELATED APPLICATION

This application claims the priority benefit of Taiwan application serial no. 100102943, filed Jan. 26, 2011. The entirety of the above-mentioned patent application is hereby incorporated by reference herein and made a part of this specification.

### TECHNICAL FIELD

This disclosure relates to a positioning method and a positioning apparatus using a differential global positioning system (DGPS).

### BACKGROUND

Typhoons cause vast damages to the Earth each year. If more instant information about the incoming typhoon can be collected, it will be possible to take precautious measures and, when necessary, help people withdraw to reduce property losses and personal casualties. The instant typhoon information is also important to typhoon research.

The heat energy of typhoons is largely absorbed from the warm sea surfaces. Therefore, information close to the sea surface such as the wind field, humidity and temperature is useful in studying the developing process of typhoons. Detecting the rainfall amount in the typhoon area is useful in forecasting the possible flood caused by typhoon. Cloud structure and atmospheric convection within the typhoon have great effects on typhoon development. There are researchers who drop dropsondes with global positioning system (GPS) into the typhoon to measure the various typhoon information mentioned above.

### SUMMARY

A positioning method is introduced herein. In this positioning method, a differential global positioning system is used to calculate a double difference of satellite distance in connection with a reference station and a receiver station. A baseline vector pointing from the reference station to the receiver station is calculated according to the double difference of satellite distance and the cosine law. The baseline vector and the position of the reference station are used to calculate the position of the receiver station. A plurality of correction coefficients are obtained according to the position of the reference station, the position of the receiver station, and a current time. The position of the receiver station is corrected according to the correction coefficients and a length of the baseline vector.

A positioning method is introduced herein. In this positioning method, a differential global positioning system is used to calculate a double difference of satellite distance in connection with a reference station and a receiver station. A baseline vector pointing from the reference station to the receiver station is calculated according to the double difference of satellite distance and the cosine law. The baseline vector and the position of the reference station are used to calculate a position of the receiver station.

A positioning method is introduced herein. In this positioning method, a differential global positioning system is used to calculate a baseline vector pointing from a reference station to a receiver station. The baseline vector and the position of the reference station are used to calculate the position of the receiver station. A plurality of correction coefficients are obtained according to the position of the reference station, the position of the receiver station, and the current time. The position of the receiver station is corrected according to the correction coefficients and the length of the baseline vector.

A positioning apparatus is introduced herein. This positioning apparatus is the receiver station and employs the above differential global positioning system. The positioning apparatus includes a balloon and a payload disposed below the balloon. The payload includes a receiver, a processor, and a transmitter. The receiver receives satellite signals of the differential global positioning system or receives the satellite signals as well as signals from the reference station. The processor calculates based on the signals received by the receiver. The transmitter wirelessly transmits a calculation result of the processor. Any one of the aforementioned positioning methods may be executed by the processor or a monitoring station. Alternatively, the processor and the monitoring station may cooperate to execute any one of the aforementioned positioning methods, in which some steps of the positioning method are executed by the processor and the remaining steps of the positioning method are executed by the monitoring station.

Several exemplary embodiments accompanied with figures are described below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram illustrating a flow chart of a positioning method according to an exemplary embodiment.

FIG. 2 is a schematic diagram illustrating the calculation of a baseline vector according to a traditional DGPS positioning method.

FIG. 3 is a schematic diagram illustrating the calculation of a baseline vector according to an exemplary embodiment.

FIG. 4 is a schematic diagram illustrating position errors of the receiver station according to an exemplary embodiment.

FIG. 5 is a schematic diagram illustrating a positioning apparatus according to an exemplary embodiment.

FIG. 6 is a schematic diagram illustrating an exemplary arrangement of positioning apparatuses according to an exemplary embodiment.

### DETAILED DESCRIPTION OF DISCLOSED EMBODIMENTS

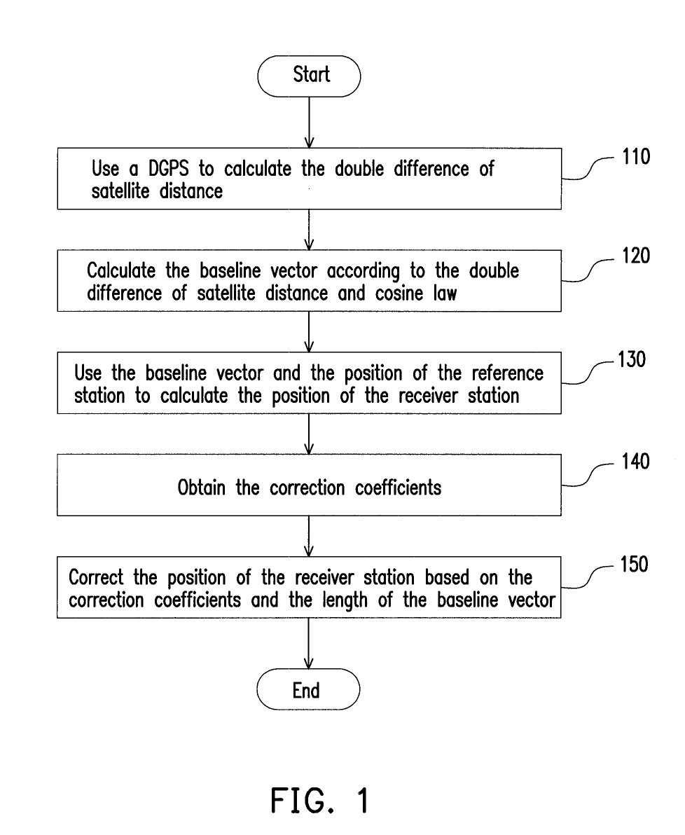

FIG. 1 is a flow chart of a positioning method according to one exemplary embodiment. This positioning method improves over the traditional DGPS positioning method. The DGPS positioning method improves over the traditional GPS positioning method by utilizing a reference station and a receiver station at different locations and achieves higher positioning accuracy by performing subtraction between the calculation results of the reference station and the receiver station. The positioning method of the present embodiment positions a receiver station based on DGPS and the position of a reference station. The key is to determine the position of the receiver with respect to the reference station. The reference station and the receiver station may be stationary or mobile devices such as, for example, the above-mentioned dropsondes or mobile GPS devices.

The flow chart of FIG. 1 is discussed below. Firstly, a DGPS scheme is used to calculate a double difference of satellite distance in connection with the reference station and the receiver station (step 110). According to the traditional DGPS scheme, the above-mentioned double difference of satellite distance is defined by equation (1) below.

rᵤᵣ^{(kl)}=[rᵤ^{(k)}−rᵣ^{(k)}]−[rᵤ^{(l)}−rᵣ^{(l)]} (1)

In equation (1), the subscripts u, r represent the receiver station and the reference station, respectively. The superscripts k, l represent two satellites of the DGPS, respectively. rᵤᵣ^{(kl)} is the double difference of satellite distance, rᵤ^{(k)} is the distance between the receiver station and the satellite k, rᵣ^{(k)} is the distance between the reference station and the satellite k, rᵤ^{(l)} is the distance between the receiver station and the satellite l, and rᵣ^{(l)} is the distance between the reference station and the satellite l.

The double difference of satellite distance rᵤᵣ^{(kl)} is obtained by a series of calculation. Firstly, the traditional DGPS is used to calculate a double difference of pseudo-range and a double difference of carrier phase in connection with the reference station and the receiver station using equations (2) and (3) below.

Δρ=ρᵤᵣ^{(kl)}=[ρᵤ^{(k)}−ρᵣ^{(k)}]−[ρᵤ^{(l)}−ρᵣ^{(l)}] (2)

Δφ=φᵤᵣ^{(kl)}=[φᵤ^{(k)}−φᵣ^{(k)}]−[φᵤ^{(l)}−φᵣ^{(l)}] (3)

Δρ and ρᵤᵣ^{(kl)} both represent the double difference of pseudo-range. Δφ and φᵤᵣ^{(kl)} both represent the double difference of carrier phase. Similar to the representation in equation (1), ρᵤ^{(k)} and φᵤ^{(k)} represent the pseudo-range and carrier phase calculated based on the signal of satellite k, and other similar variables are represented in a similar manner. Any one of the pseudo-range ρ, namely ρᵤ^{(k)}, ρᵣ^{(k)}, ρᵤ^{(l)} and ρᵣ^{(l)} can be represented by equation (4) below.

ρ=r+I_{ρ}+T_{ρ}+c(δt^{s}−δtᵤ)+ε_{ρ} (4)

In equation (4), r is the distance between the reference station or the receiver station and one of the satellites, i.e. one of rᵤ^{(k)}, rᵣ^{(k)}, rᵤ^{(l)} and rᵣ^{(l)}, I_{ρ} and T_{ρ} represents the distance differences caused by the delay of satellite signal transmitting through the ionosphere and the troposphere, respectively, c represents the speed of light, δₜₛ represents the clock error of one of the satellites, δₜᵤ represents the clock error of the reference station or the receiver station, and ε_{ρ} represents the distance error caused by noise.

On the other hand, any carrier phase φ of φᵤ^{(k)}, φᵣ^{(k)}, φᵤ^{(l)} and φᵣ^{(l)} can be represented by equation (5) below.

φ=λ⁻¹[r+I_{φ}+T_{φ}+c(δt^{s}−δtᵤ)]−N_{φ}+ε_{φ} (5)

In equation (5), λ is the wavelength of the satellite signal, I_{φ} and T_{φ} represent the distance errors caused by the delay of satellite signal transmitting through the ionosphere and the troposphere, respectively, N_{φ} is the integer ambiguity, and ε_{φ} is the phase error caused by noise.

If each pseudo-range ρ in equation (2) is represented by equation (4) and each carrier phase φ in equation (3) is represented by equation (5), some terms are very close in value and can therefore cancel each other out, thus resulting in the following equations (6) and (7).

Δρ=ρᵤᵣ^{(kl)}≅rᵤᵣ^{(kl)}+ε_{ρ,ur}^{(kl)} (6)

Δφ=φᵤᵣ^{(kl)}≅λ⁻¹rᵤᵣ^{(kl)}−N_{φ,ur}^{(kl)}+ε_{φ,ur}^{(kl)} (7)

Positioning by means of the carrier phase φ is more accurate than positioning by means of the pseudo-range ρ, however, the double difference of integer ambiguity N_{φ,ur}^{(kl)} must be calculated first. Therefore, the next step is to calculate the double difference of integer ambiguity N_{φ,ur}^{(kl)} in the double difference of carrier phase, Δφ. Firstly, the following two references [1], [2] give equations (8), (9) below.

[1] B. Li, Y. M. Feng, and Y. Z. Shen, “Three carrier ambiguity resolution: Distance-independent performance demonstrated using semi-generated triple frequency GPS signals,” GPS Solut., vol. 14, pp. 177-184, 2010.

[2] Y. M. Feng, “GNSS three carrier ambiguity resolution using ionosphere-reduced virtual signals,” J Geod., vol. 82, pp. 847-862, 2008.

Δ ρ̅ᵢ=Δ r̅+Δ T̅+ΔĪᵢ+Δ ε̅_{ρ} (8)

Δ φ̅ᵢ=Δ r̅′Δ T̅−ΔĪᵢ−λᵢΔ N̅ᵢ+Δ ε̅_{φ} (9)

Δ ρ̅ᵢ and Δ φ̅ᵢ are the double differences of the code measurement vector and the phase measurement vector, respectively, when multiple GPS satellites and satellite signals are taken into account. The equations (8), (9) are very similar to the equations (4) to (7) and therefore, explanation thereof is not repeated herein. Then, the combined double difference Δ ρ̅_{(i,j,k)} of the code measurement vector and the combined double difference Δ φ̅_{(i,j,k)} of the phase measurement vector are defined by equations (10), (11) below.

$$\begin{matrix}Δ {\overline{ρ}}_{( i , j , k )} = \frac{{if}_{1} Δ {\overline{ρ}}_{1} + {jf}_{2} Δ {\overline{ρ}}_{2} + {kf}_{5} Δ {\overline{ρ}}_{5}}{{if}_{1} + {jf}_{2} + {kf}_{5}} & ( 10 ) \\ Δ {\overline{φ}}_{( i , j , k )} = \frac{{if}_{1} Δ {\overline{φ}}_{1} + {jf}_{2} Δ {\overline{φ}}_{2} + {kf}_{5} Δ {\overline{φ}}_{5}}{{if}_{1} + {jf}_{2} + {kf}_{5}} & ( 11 )\end{matrix}$$

In equations (10) and (11), f₁, f₂ and f₅ are frequencies of the GPS satellite signal at frequency bands L1, L2 and L5, respectively. Δ N̅_{(0,1,-1)} is then calculated according to equation (12) below.

$$\begin{matrix}Δ {\overline{N}}_{( 0 , 1 , - 1 )} = round \{ \frac{Δ {\overline{ρ}}_{( 0 , 1 , - 1 )} - Δ {\overline{φ}}_{( 0 , 1 , - 1 )}}{{λ}_{( 0 , 1 , - 1 )}} \} \\ wherein , & ( 12 ) \\ Δ {\overline{N}}_{( i , j , k )} = i Δ {\overline{N}}_{1} + j Δ {\overline{N}}_{2} + k Δ {\overline{N}}_{5} & ( 13 ) \\ {λ}_{( i , j , k )} = \frac{c}{{if}_{1} + {jf}_{2} + {kf}_{5}} & ( 14 )\end{matrix}$$

Δ N̅_{(1,-6,5)} is then estimated using the least-squares method according to equation (15) below.

$$[ \begin{matrix}Δ {\overline{ϕ}}_{( 0 , 1 , - 1 )} + {λ}_{( 0 , 1 , - 1 )} Δ {\overline{N}}_{( 0 , 1 , - 1 )} \\ Δ {\overline{ϕ}}_{( 1 , - 6 , 5 )}\end{matrix} ] = [ \begin{matrix}{A}^{\overline{\_}} & 0 \\ {A}^{\overline{\_}} & {λ}_{( 1 , - 6 , 5 )} {I}^{\overline{\_}}\end{matrix} ] [ \begin{matrix}{\overline{x}}_{ur} \\ Δ {\overline{N}}_{( 1 , - 6 , 5 )}\end{matrix} ] \qquad ( 15 )$$

In equation (15), x̅ᵤᵣ is the baseline vector pointing from the reference station to the receiver station and I̅ is the identity matrix. A̅ is an observation matrix that is defined by equation (16) below.

$${A}^{\overline{\_}} = [ \begin{matrix}{\hat{s}}_{r}^{( 2 )} - {\hat{s}}_{r}^{( 1 )} \\ {\hat{s}}_{r}^{( 3 )} - {\hat{s}}_{r}^{( 1 )} \\ ⋮ \\ {\hat{s}}_{r}^{( K )} - {\hat{s}}_{r}^{( 1 )}\end{matrix} ] \qquad ( 16 )$$

In equation (16), Ŝᵣ^{(l)} to Ŝᵣ^{(K)} are unit vectors pointing from the reference station to the first and to the k^{th} GPS satellites, respectively. Next, Δ N̅_{(4,0,-3)} is estimated using the least-squares method according to equation (17) below.

$$[ \begin{matrix}Δ {\overline{ϕ}}_{( 0 , 1 , - 1 )} + {λ}_{( 0 , 1 , - 1 )} Δ {\overline{N}}_{( 0 , 1 , - 1 )} \\ Δ {\overline{ϕ}}_{( 4 , 0 , - 3 )}\end{matrix} ] = [ \begin{matrix}{A}^{\overline{\_}} & 0 \\ {A}^{\overline{\_}} & {λ}_{( 4 , 0 , - 3 )} {I}^{\overline{\_}}\end{matrix} ] [ \begin{matrix}{\overline{x}}_{ur} \\ Δ {\overline{N}}_{( 4 , 0 , - 3 )}\end{matrix} ] \qquad ( 17 )$$

According to the calculations above, the double differences of integer ambiguity Δ N̅_{(1,0,0)}, Δ N̅_{(0,1,0)} and Δ N̅_{(0,0,1)} corresponding to the three GPS frequencies f₁, f₂, and f₅ can thus be obtained, which correspond to the double difference of integer ambiguity N_{φ,ur}^{(kl)} in equation (7), as represented by equation (18) below.

$$[ \begin{matrix}Δ {\overline{N}}_{( 1 , 0 , 0 )} \\ Δ {\overline{N}}_{( 0 , 1 , 0 )} \\ Δ {\overline{N}}_{( 0 , 0 , 1 )}\end{matrix} ] = [ \begin{matrix}- 18 & - 3 & 1 \\ - 23 & - 4 & 1 \\ - 24 & - 4 & 1\end{matrix} ] [ \begin{matrix}Δ {\overline{N}}_{( 0 , 1 , - 1 )} \\ Δ {\overline{N}}_{( 1 , - 6 , 5 )} \\ Δ {\overline{N}}_{( 4 , 0 , - 3 )}\end{matrix} ] \qquad ( 18 )$$

Details of equations (8) to (18) are discussed in the above-mentioned references [1], [2] and, therefore, explanation thereof is not repeated herein.

In equation (7), the double difference of carrier phase Δφ is known, and GPS satellite signal wavelength λ and the double difference of integer ambiguity N_{φ,ur}^{(kl)} are also known. Let the double difference of noise error ε_{φ,ur}^{(kl)} be approximated to zero, the double difference of satellite distance rᵤᵣ^{(kl)} can thus be obtained.

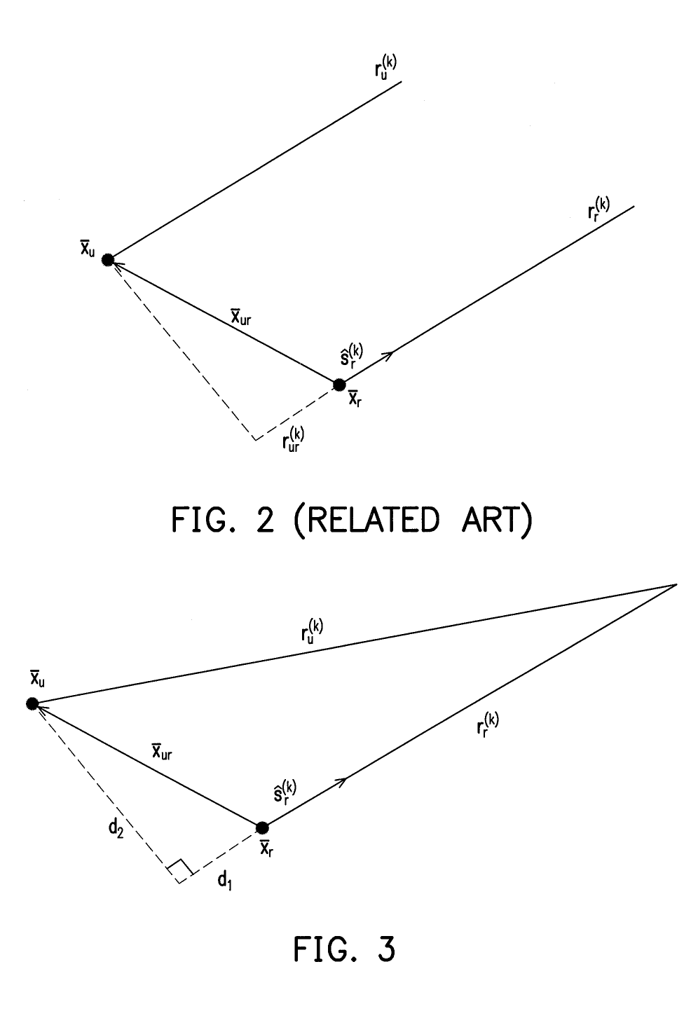

Referring to FIG. 1 again, the next step is to calculate the baseline vector according to the double difference of satellite distance rᵤᵣ^{(kl)} and the cosine law (step 120). As used herein, the term baseline refers to the line segment from the reference station to the receiver station, and the baseline vector refers to the vector pointing from the reference station to the receiver station. Referring to FIG. 2 and FIG. 3, FIG. 2 illustrates the calculation of the baseline vector according to the traditional DGPS positioning method, and FIG. 3 illustrates the calculation of the baseline vector according to an exemplary embodiment. As described above, rᵣ^{(k)} is the distance between the reference station and the satellite k, and rᵤ^{(k)} is the distance between the receiver station and the satellite k, where rᵤᵣ^{(k)}=rᵤ^{(k)}−rᵣ^{(k)}. x̅ᵣ is the position vector of the reference station, x̅ᵤ is the position vector of the receiver station, and x̅ᵤᵣ is the baseline vector. Ŝᵣ^{(k)} is the unit vector pointing from the reference station to the satellite k, and other vectors are represented in a similar manner, for example, Ŝᵣ^{(l)} is the unit vector pointing from the reference station to the satellite l.

As shown in FIG. 2, according to the traditional DGPS positioning method, the distance between the reference station and the receiver station is relatively short, and the baseline length is far less than the distance between the two stations and the satellites. Therefore, it can be assumed that the two line segments corresponding to rᵣ^{(k)} and rᵤ^{(k)} are parallel to each other. Under this assumption, the baseline vector x̅ᵤᵣ can be easily calculated. The baseline vector x̅ᵤᵣ is the position of the receiver station relative to the reference station, and the position of the reference station is known. Therefore, the position of the receiver station x̅ᵤ can be obtained by adding the baseline vector x̅ᵤᵣ to the position of the reference station x̅ᵣ.

However, when the baseline length is as great as one hundred kilometers, the parallel line segment assumption adopted in the tradition DGPS positioning method is no longer appropriate. Therefore, the present embodiment does not adopt the parallel line segment assumption. Instead, the trigonometric cosine law is used which can make the calculation of the baseline vector x̅ᵤᵣ more accurate. Therefore, step 120 may be referred to as a geometrical correction step. As shown in FIG. 3, the reference station x̅ᵣ, the receiver station x̅ᵤ and the satellite k can define a triangle. According the cosine law, rᵤ^{(k)} may be expressed as a function of rᵣ^{(d)}, x̅ᵤᵣ and Ŝᵣ^{(k)}, as shown in the equation (19) below.

$${r}_{u}^{( k )} = {\{ {[ {r}_{r}^{( k )} ]}^{2} + {\overline{x}}_{ur} \cdot {\overline{x}}_{ur} + 2 {r}_{r}^{( k )} [ - {\overline{x}}_{ur} \cdot {\hat{s}}_{r}^{( k )} ] \}}^{1 / 2} ≅ {r}_{r}^{( k )} - {\overline{x}}_{ur} \cdot {\hat{s}}_{r}^{( k )} + \frac{{\overline{x}}_{ur} \cdot {\overline{x}}_{ur}}{2 {r}_{r}^{( k )}} - \frac{{[ {\overline{x}}_{ur} \cdot {\hat{s}}_{r}^{( k )} ]}^{2}}{2 {r}_{r}^{( k )}} + \frac{[ {\overline{x}}_{ur} \cdot {\hat{s}}_{r}^{( k )} ] ( {\overline{x}}_{ur} \cdot {\overline{x}}_{ur} )}{{2 [ {r}_{r}^{( k )} ]}^{2}} - \frac{{( {\overline{x}}_{ur} \cdot {\overline{x}}_{ur} )}^{2}}{{8 [ {r}_{r}^{( k )} ]}^{3}} - {\frac{1}{2} [ \frac{{\overline{x}}_{ur} \cdot {\hat{s}}_{r}^{( k )}}{{r}_{r}^{( k )}} ]}^{3} + {\frac{3}{4} [ \frac{{\overline{x}}_{ur} \cdot {\hat{s}}_{r}^{( k )}}{{r}_{r}^{( k )}} ]}^{2} \frac{{\overline{x}}_{ur} \cdot {\overline{x}}_{ur}}{{[ {r}_{r}^{( k )} ]}^{2}} + … \qquad ( 19 )$$

rᵣ^{(k)} can also be similarly expressed according to the cosine law. The reference station x̅ᵣ, the receiver station x̅ᵤ and the satellite l can define another triangle (not shown), where rᵣ^{(l)} and rᵤ^{(l)} can also be similarly expressed according to the cosine law. As such, four similar equations including equation (19) can be obtained, which correspond to rᵤ^{(k)}, rᵣ^{(k)}, rᵣ^{(l)} and rᵤ^{(l)} respectively. By substituting the four equations into equation (1), the following equation (20) can be obtained.

$${r}_{ur}^{( kl )} = - [ {\hat{s}}_{r}^{( k )} - {\hat{s}}_{r}^{( l )} ] \cdot {\overline{x}}_{ur} + \{ \frac{{\overline{x}}_{ur} \cdot {\overline{x}}_{ur}}{2 {r}_{r}^{( k )}} - \frac{{[ {\overline{x}}_{ur} \cdot {\hat{s}}_{r}^{( k )} ]}^{2}}{2 {r}_{r}^{( k )}} + \frac{[ {\overline{x}}_{ur} \cdot {\hat{s}}_{r}^{( k )} ] ( {\overline{x}}_{ur} \cdot {\overline{x}}_{ur} )}{{2 [ {r}_{r}^{( k )} ]}^{2}} - \frac{{( {\overline{x}}_{ur} \cdot {\overline{x}}_{ur} )}^{2}}{{8 [ {r}_{r}^{( k )} ]}^{3}} - {\frac{1}{2} [ \frac{{\overline{x}}_{ur} \cdot {\hat{s}}_{r}^{( k )}}{{r}_{r}^{( k )}} ]}^{3} + {\frac{3}{4} [ \frac{{\overline{x}}_{ur} \cdot {\hat{s}}_{r}^{( k )}}{{r}_{r}^{( k )}} ]}^{2} \frac{{\overline{x}}_{ur} \cdot {\overline{x}}_{ur}}{{[ {r}_{r}^{( k )} ]}^{2}} \} - \{ \frac{{\overline{x}}_{ur} \cdot {\overline{x}}_{ur}}{2 {r}_{r}^{( l )}} - \frac{{[ {\overline{x}}_{ur} \cdot {\hat{s}}_{r}^{( l )} ]}^{2}}{2 {r}_{r}^{( l )}} + \frac{[ {\overline{x}}_{ur} \cdot {\hat{s}}_{r}^{( l )} ] ( {\overline{x}}_{ur} \cdot {\overline{x}}_{ur} )}{{2 [ {r}_{r}^{( l )} ]}^{2}} - \frac{{( {\overline{x}}_{ur} \cdot {\overline{x}}_{ur} )}^{2}}{{8 [ {r}_{r}^{( l )} ]}^{3}} - {\frac{1}{2} [ \frac{{\overline{x}}_{ur} \cdot {\hat{s}}_{r}^{( l )}}{{r}_{r}^{( l )}} ]}^{3} + {\frac{3}{4} [ \frac{{\overline{x}}_{ur} \cdot {\hat{s}}_{r}^{( l )}}{{r}_{r}^{( l )}} ]}^{2} \frac{{\overline{x}}_{ur} \cdot {\overline{x}}_{ur}}{{[ {r}_{r}^{( l )} ]}^{2}} \} \qquad ( 20 )$$

In equation (20), rᵣ^{(k)} and rᵣ^{(l)} in the denominators are extremely large in value and, therefore, terms other than −[Ŝᵣ^{(k)}−Ŝᵣ^{(l)}]· x̅ᵤᵣ are far less than −[Ŝᵣ^{(k)}−−Ŝᵣ^{(l)}]· x̅ᵤᵣ. As such, equation (20) may be rewritten as follows.

rᵤᵣ^{(kl)}=−[Ŝᵣ^{(k)}−Ŝᵣ^{(l)}]· x̅ᵤᵣ+αᵤᵣ^{(kl)} (21)

In equation (21), −[Ŝᵣ^{(k)}−Ŝᵣ^{(l)}]· x̅ᵤᵣ is the primary term and αᵤᵣ^{(kl)} is the secondary term which is equal to the sum of all the terms on the right-hand side of equation (20) except the primary term −[Ŝᵣ^{(k)}−Ŝᵣ^{(l)}]· x̅ᵤᵣ.

In this exemplary embodiment, the baseline vector x̅ᵤᵣ is calculated according to equation (20). Firstly, set the secondary term αᵤᵣ^{(kl)} in equation (20) to be zero, and then the equation (20) and the least-squares method are used to calculate the first estimate x̅_{ur,0} of the baseline vector x̅ᵤᵣ. Then, the first estimate x̅_{ur,0} is applied into the secondary term αᵤᵣ^{(kl)} of equation (20), and equation (20) and the least-squares method are used again to calculate the next estimate x̅_{ur,1} of the baseline vector x̅ᵤᵣ. The previous estimate is repeatedly applied into the secondary term αᵤᵣ^{(kl)}, and equation (20) and the least-squares method are repeatedly used to calculate the next estimate until the estimate of the baseline vector x̅ᵤᵣ satisfies a predetermined convergent criterion. This estimate satisfying the predetermined convergent criterion is taken as the baseline vector x̅ᵤᵣ.

Referring to FIG. 1 again, the next step is to calculate the position of the receiver station x̅ᵤ using the baseline vector x̅ᵤᵣ and the position x̅ᵣ of the reference station (step 130). As described above, the position of the receiver station x̅ᵤ can be obtained by adding the baseline vector x̅ᵤᵣ to the position of the reference station x̅ᵣ. The error of the receiver station position that undergoes the geometric correction of step 120 is already less than that obtained through the traditional DGPS positioning method. However, the receiver station position undergoes more corrections in the exemplary embodiment, for example, the residual error correction of later steps 140 and 150.

A plurality of correction coefficients is obtained according to the reference station position, the receiver station position, and the current time at step 140. A simulation calculation shows that the receiver station position obtained at step 130 still has an error with respect to the real position, and the error is directly proportional to the cube of the length of the baseline vector. The correction coefficients represent the ratio of the error to the cube of the baseline vector length. In the exemplary embodiment, three coefficients αₓ, α_{y}, α_{z} are used, which respectively correspond to the coordinate axes x, y, z of the position at which the receiver station is located. The coordinate axes x, y are parallel to the earth surface, and z is the height axis.

The position of the GPS satellites will affect the correction coefficients αₓ, α_{y}, α_{z}. Therefore, the correction coefficients have correlation with the current time and the latitude and longitude of the receiver station. In addition, the azimuth angle between the baseline vector x̅ᵤᵣ and the north direction will also affect the correction coefficients. The correction coefficients αₓ, α_{y}, α_{z} may be obtained by simulation calculation. With respect to each combination of the current time, latitude and longitude, azimuth angle, and baseline vector length, all the satellite signals to be received by the reference station and the receiver station are known. The receiver station position can be calculated using the positioning method of FIG. 1. By comparing this calculated receiver station position against the real receiver station position, the position errors on the three coordinate axes can be obtained. The correction coefficients αₓ, α_{y}, α_{z} corresponding to the three coordinate axes are calculated by dividing the position errors on the three coordinate axes by the cube of the baseline vector length, respectively. As such, a correction coefficient lookup table may be established by calculation in advance. At step 140, the current time, the latitude and longitude of the receiver station, and the azimuth angle between the baseline vector x̅ᵤᵣ and the north direction may be used as indices to obtain the corresponding correction coefficients αₓ, α_{y}, α_{z} from the lookup table.

Referring to FIG. 1 again, the next step is to correct the receiver station position obtained at step 130 according to the correction coefficients and the baseline vector length (step 150). Firstly, the following equation (22) is calculated.

ε_{α}=α_{α}R³ (22)

In equation (22), α=x, y, z, ε_{α} represents the receiver station position errors corresponding to the three coordinate axes, i.e. the desired correction amount. α_{α} represents the correction coefficients αₓ, α_{y}, α_{z}, R is the length of the baseline vector x̅ᵤᵣ.

The correction coefficients εₓ, ε_{y}, ε_{z} can thus be used to correct the corresponding coordinates of the receiver station to achieve the final estimated receiver station.

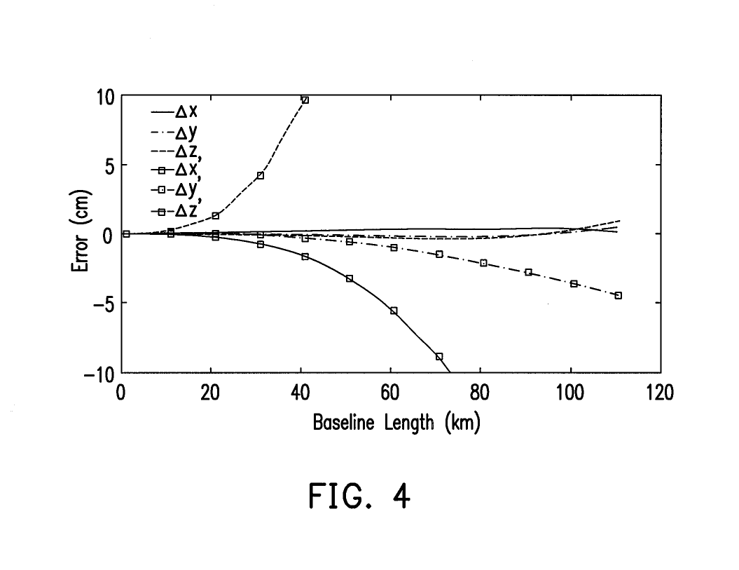

The receiver station position that undergoes the geometric correction of step 120 is already more accurate than the traditional DGPS positioning. Having undergone the residual error corrections of step 140 and 150, the receiver station position is even more accurate. FIG. 4 illustrates position errors of a receiver station according to one exemplary embodiment, where the horizontal axis represents the baseline vector length, the vertical axis represents the receiver station position errors with respect to the x, y, z coordinate axes. Δx′, Δy′, Δz′ are the position errors of the receiver station that undergo only the geometric correction, and Δx, Δy, Δz are the position errors of the receiver station that undergo the geometric correction as well as the residual error corrections. As shown in FIG. 4, if there are no residual error corrections, the receiver station position already has an error of ten centimeters for a baseline length of 40 kilometers. If there are the residual error corrections, the receiver station position only has an error of less than one centimeter even the baseline length is greater than 100 kilometers.

The positioning method of FIG. 1 has two simplified implementations. In the first simplified implementation, the residual error corrects of steps 140 and 150 are omitted and the receiver station position obtained at step 130 is used as the final position. In another simplified implementation, the geometric correction of step 120 is omitted. The traditional DGPS positioning method is first used to estimate the baseline vector and calculate the receiver station position, and then the residual error corrections of steps 140 and 150 are performed. Both the two simplified implementation of the positioning method can result in a more accurate positioning than the traditional DGPS positioning method.

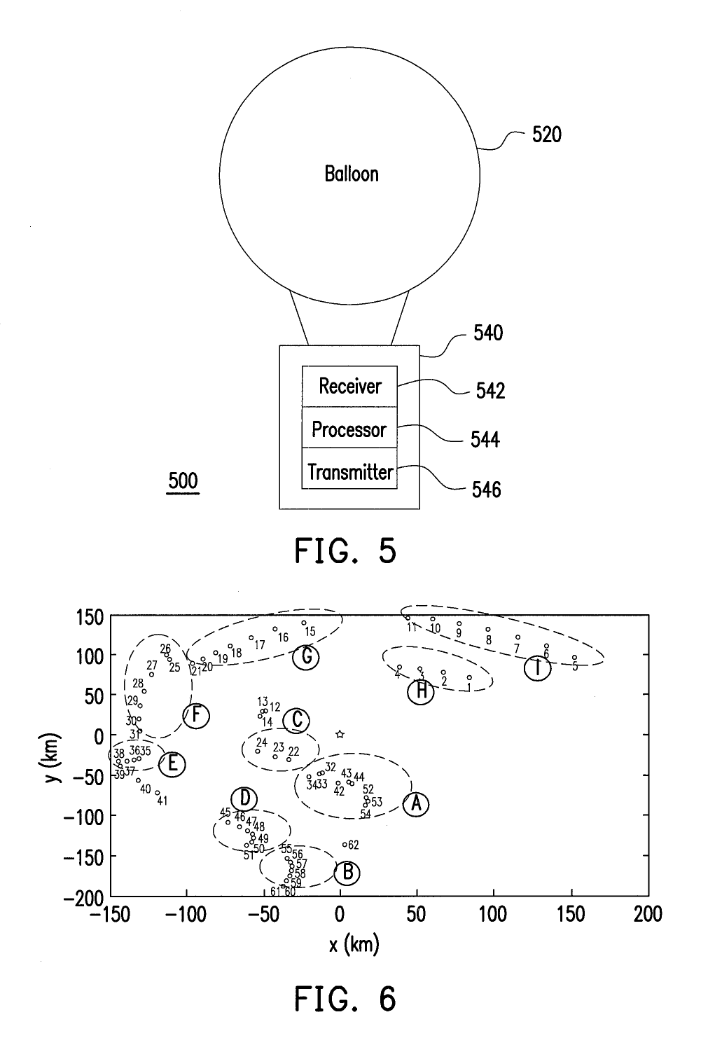

The positioning method described above can apply in any fields that need precise positioning. For example, a plurality of positioning apparatus that support the above positioning method can be fabricated and dropped into a typhoon to timely monitor the developing process and travelling path of the typhoon. FIG. 5 illustrates a positioning apparatus 500 using DGPS according to one embodiment of the disclosure.

The positioning apparatus 500 may be dropped into the typhoon to serve as the above receiver station. The positioning apparatus 500 includes a balloon 520 and a payload 540 disposed below the balloon 520. The balloon 520 can carry the payload floating in the sky to facilitate the payload 540 to collect monitoring data. The payload 540 includes a receiver 542, a processor 544, and a transmitter 546. The receiver 542 receives the GPS satellite signals or receives GPS satellite signals as well as signals from the reference station. The reason of receiving signals from the reference station is that the positioning apparatus 500 can estimate its position according to the above positioning method and needs to receive relevant data from the reference station for this estimation. The processor 544 calculates based on the signals received by the receiver 542. The transmitter 546 wirelessly transmits the calculation results of the processor 544. For example, the transmitter 546 may be a radio-frequency (RF) circuit for transmitting wireless signals.

FIG. 6 illustrates an exemplary distribution of positioning apparatuses in a typhoon. If an airplane flying through the typhoon along a preset path drops a positioning apparatus 500 at preset interval, after being blown by the typhoon, the positioning apparatus 500 may be distributed in a pattern similar to that in FIG. 6. FIG. 6 is a top view of the positioning apparatus distribution, where the horizontal and vertical axes are the x coordinate and y coordinate of the positioning apparatus, respectively. FIG. 6 illustrates a total of 62 positioning apparatus labelled as 1 to 62, respectively. Each of the positioning apparatus is the same as the positioning apparatus 500 of FIG. 5. Adjacent positioning apparatus are grouped into a cluster. There are nine clusters, namely, A to I, in FIG. 6. For example, cluster H includes positioning apparatuses 1 to 4, and cluster I includes positioning apparatuses 5 to 11.

These positioning apparatuses may first use the traditional DGPS positioning method to preliminarily estimate their positions and self-define the clusters according to the distances from one another and the positioning apparatus distribution. In each cluster, the positioning apparatus most close to the center of the cluster is selected as the reference station in the above-described positioning method, and the remaining positioning apparatus in the same cluster serve as the receiver stations in the above-described positioning method.

The reference station of each cluster may directly use the traditional GPS positioning method to estimate its position, or use the traditional DGPS positioning method to estimate its position under the assistance of another reference station. The above estimated reference station position may be used by the receiver stations in the same cluster to carry out the positioning method of FIG. 1 or either of the simplified implementations for accurate positioning.

The processor 544 of the positioning apparatus 500 can execute the positioning method of FIG. 1 or either of the simplified implementations. Then, the positioning apparatus 500 may transmit, through the transmitter 546, its position that is obtained by estimation and corrections for a specific monitoring station to receive. In addition, the payload 540 may also include various sensors (not shown), for allowing the processor 544 to collect monitoring data such as wind field, temperature, air pressure, humidity, and rainfall amount. These data may be transmitted through the transmitter 546 to the monitoring station for real-time monitoring.

The positioning method of FIG. 1 or its simplified implementations may also be executed by the above monitoring station. In this case, the processor 544 uses the traditional GPS positioning method to conduct preliminary positioning, and then transmits its position to the monitoring station through the transmitter 546. Next, the monitoring station may define the clusters based on the distribution of the positioning apparatuses and designate the reference station for each cluster in the manner illustrated in FIG. 6, and then execute the positioning method of FIG. 1 or either one of the simplified implementations to accurately position each positioning apparatus.

In addition to the two implementations as described above, the processor 544 may also execute some steps of the positioning method and the monitoring station may execute the remaining steps of the positioning method. In this case, the positioning apparatus 500 must transmit the data obtained in those some steps to the monitoring station for the monitoring station to continue the subsequent steps.

In summary, this disclosure improves the traditional DGPS positioning method by adopting geometric correction and residual error corrections and can accurately estimate the coordinates of the positioning apparatus. Even when the baseline length is greater than 100 kilometers, the estimation can be accurate to centimeter-level, making the disclosed positioning method and apparatus beneficial in various applications. This disclosure replaces the parachutes of traditional dropsondes with balloons, which can prolong the floating time of the positioning apparatus such that the positioning apparatus can provide more observation data. This disclosure may be used for real-time monitoring of a typhoon. This disclosure may also be applied in any technical field that needs precise positioning.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A positioning method, comprising:
using a differential global positioning system to calculate a double difference of a satellite distance in connection with a reference station and a receiver station;
calculating a baseline vector pointing from the reference station to the receiver station according to the double difference of satellite distance and cosine law;
using the baseline vector and a position of the reference station to calculate a position of the receiver station;
obtaining a plurality of correction coefficients according to the position of the reference station, the position of the receiver station, and a current time; and
correcting the position of the receiver station according to the correction coefficients and a length of the baseline vector.

2. The positioning method according to claim 1, wherein the step of calculating the double difference of satellite distance comprises:
using the differential global positioning system to calculate a double difference of pseudo-range and a double difference of carrier phase in connection with the reference station and the receiver station;
calculating a double difference of integer ambiguity in the double difference of carrier phase according to the double difference of pseudo-range, the double difference of carrier phase, and a plurality of transmitting signal frequencies of the differential global positioning system; and
calculating the double difference of satellite distance according to the double difference of carrier phase and the double difference of integer ambiguity.

3. The positioning method according to claim 1, wherein the double difference of satellite distance is calculated from four distances between the reference station/the receiver station and two satellites of the differential global positioning system according to a first equation, and the step of calculating the baseline vector comprises:
with respect to two triangles defined by the reference station, the receiver station and each of the two satellites, applying the cosine law to the four distances respectively and applying resultant equations into the first equation to obtain a second equation; and
calculating the baseline vector according to the second equation.

4. The positioning method according to claim 3, wherein the second equation comprises a primary term and a secondary term, and the step of calculating the baseline vector according to the second equation comprises:
setting the secondary term to be zero and calculating an estimate of the baseline vector according to the second equation;
applying the estimate into the secondary term, and calculating a next estimate of the baseline vector according to the second equation; and
repeating the previous step until the estimate satisfies a convergent criterion, and then taking the estimate satisfying the convergent criterion as the baseline vector.

5. The positioning method according to claim 1, wherein the step of obtaining the correction coefficients comprises:
using the current time, a latitude and a longitude of the receiver station, and an azimuth angle between the baseline vector and a north direction as indices to obtain the correction coefficients from a lookup table.

6. The positioning method according to claim 1, wherein the number of the correction coefficients is three and the three correction coefficients are respectively corresponding to three coordinate axes of a position at which the receiver station is located.

7. The positioning method according to claim 6, wherein the step of correcting the position of the receiver station comprises:
using each of the correction coefficients and a cube of the length of the baseline vector to calculate a correction amount corresponding to each of the correction coefficients; and
using each of the correction amounts to correct a corresponding coordinate of the position of the receiver station.

8. A positioning method, comprising:
using a differential global positioning system to calculate a double difference of satellite distance in connection with a reference station and a receiver station;
calculating a baseline vector pointing from the reference station to the receiver station according to the double difference of satellite distance and cosine law; and
using the baseline vector and a position of the reference station to calculate a position of the receiver station.

9. The positioning method according to claim 8, wherein the double difference of satellite distance is calculated from four distances between the reference station/the receiver station and two satellites of the differential global positioning system according to a first equation, and the step of calculating the baseline vector comprises:
with respect to two triangles defined by the reference station, the receiver station and each of the two satellites, applying the cosine law to the four distances respectively and applying resultant equations into the first equation to obtain a second equation; and
calculating the baseline vector according to the second equation.

10. The positioning method according to claim 9, wherein the second equation comprises a primary term and a secondary term, and the step of calculating the baseline vector according to the second equation comprises:
setting the secondary term to be zero and calculating an estimate of the baseline vector according to the second equation;
applying the estimate into the secondary term, and calculating a next estimate of the baseline vector according to the second equation; and
repeating the previous step until the estimate satisfies a convergent criterion, and then taking the estimate satisfying the convergent criterion as the baseline vector.

11. A positioning method, comprising:
using a differential global positioning system to calculate a baseline vector pointing from a reference station to a receiver station;
using the baseline vector and a position of the reference station to calculate a position of the receiver station;
obtaining a plurality of correction coefficients according to the position of the reference station, the position of the receiver station, and a current time; and
correcting the position of the receiver station according to the correction coefficients and a length of the baseline vector.

12. The positioning method according to claim 11, wherein the step of obtaining the correction coefficients comprises:
using the current time, a latitude and a longitude of the receiver station, and an azimuth angle between the baseline vector and a north direction as indices to obtain the correction coefficients from a lookup table.

13. The positioning method according to claim 11, wherein the number of the correction coefficients is three and the three correction coefficients are respectively corresponding to three coordinate axes of a position at which the receiver station is located.

14. The positioning method according to claim 13, wherein the step of correcting the position of the receiver station comprises:
using each of the correction coefficients and a cube of the length of the baseline vector to calculate a correction amount corresponding to each of the correction coefficients; and
using each of the correction amounts to correct a corresponding coordinate of the position of the receiver station.

15. A positioning apparatus employing the differential global positioning system according to claim 1, in which the positioning apparatus is the receiver station, the positioning apparatus comprising:
a balloon;
a payload disposed below the balloon and comprising:
a receiver receiving satellite signals of the differential global positioning system or receiving the satellite signals as well as signals from the reference station;
a processor calculating based on the signals received by the receiver; and
a transmitter wirelessly transmitting a calculation result of the processor, wherein the processor executes the positioning method according to claim 1, or a monitoring station executes the positioning method, or the processor executes some steps of the positioning method and the monitoring station executes the remaining steps of the positioning method.

16. A positioning apparatus employing the differential global positioning system according to claim 8, in which the positioning apparatus is the receiver station, the positioning apparatus comprising:
a balloon;
a payload disposed below the balloon and comprising:
a receiver receiving satellite signals of the differential global positioning system or receiving the satellite signals as well as signals from the reference station;
a processor calculating according to the signals received by the receiver; and
a transmitter wirelessly transmitting a calculation result of the processor, wherein the processor executes the positioning method according to claim 8, or a monitoring station executes the positioning method, or the processor executes some steps of the positioning method and the monitoring station executes the remaining steps of the positioning method.

17. A positioning apparatus employing the differential global positioning system according to claim 11, in which the positioning apparatus is the receiver station, the positioning apparatus comprising:
a balloon;
a payload disposed below the balloon and comprising:
a receiver receiving satellite signals of the differential global positioning system or receiving the satellite signals as well as signals from the reference station;
a processor calculating according to the signals received by the receiver; and a transmitter wirelessly transmitting a calculation result of the processor, wherein the processor executes the positioning method according to claim 11, or a monitoring station executes the positioning method, or the processor executes some steps of the positioning method and the monitoring station executes the remaining steps of the positioning method.
